(19) United States
(12) Patent Application Publication
(10) Pub. No.: US 2025/0208766 A1
(43) Pub. Date: Jun. 26, 2025

(54) STORAGE SYSTEM AND STATE MANAGEMENT METHOD FOR RESOURCE OPERATION

(71) Applicant: Hitachi Vantara, Ltd, Yokohama-shi (JP)

(72) Inventor: So CHANO, Tokyo (JP)

(73) Assignee: Hitachi Vantara, Ltd., Yokohama-shi (JP)

(21) Appl. No.: 18/829,891

(22) Filed: Sep. 10, 2024

(30) Foreign Application Priority Data
Dec. 20, 2023 (JP) 2023-214511

(51) Int. Cl. G06F 3/06

(52) U.S. Cl. CPC G06F 3/0619; G06F 3/0647; G06F 3/067

(57) ABSTRACT

A storage system includes first and second storages on a cloud. The storage system executes several resource operations including copying data of a server at another site to a second storage via a first volume of a first storage. The storage system manages, for each type of the operation, the correspondence relationship between each state of the resource associated with the execution of each resource operation and the transition destination state to which each state is to make a transition when the execution of each resource operation is completed. The storage system manages the current state of the resource associated with the execution of the resource operation, and determines the transition destination state associated with the current state as the state to which the current state should transition, on the basis of the execution result as to whether the resource operation has been completed normally and the correspondence relationship.

### BACKGROUND OF THE INVENTION

### 1. Field of the Invention

The present invention relates to a storage system and a state management method for resource operation.

### 2. Description of the Related Art

In information systems, there is a need to perform storage operations without requiring skill or labor. For example, JP-7190530-B1 discloses a system that prevents erroneous operations by evaluating the risk of erroneous operations by users who perform storage operations for a plurality of tenants.

### SUMMARY OF THE INVENTION

However, in the conventional technology disclosed in the above-mentioned JP-7190530-B1, the state of a series of storage operations from start to finish is not managed.

In recent years, there has been an increasing demand for hybrid clouds that combine on-premise computing resources with public cloud computing resources. In a hybrid cloud, a migration is executed that includes a series of storage operations for migrating on-premise computing resources to a public cloud via an intermediate volume, for example.

Here, in the cloud, inconveniences may occur, such as data loss when a storage operation is started again due to a user's operational error, or an increase in cloud capacity charges if unnecessary intermediate volumes are not deleted.

However, in conventional technologies, there is no state management for storage operations, and therefore when performing operations that include a series of storage operations in a hybrid cloud in order to avoid the inconveniences described above, it is unclear from what state the operations can be performed, which makes it difficult to execute the operations.

The present invention has been made in consideration of the above circumstances, and has an object to make it possible to easily execute operations including a series of storage operations in a hybrid cloud.

An aspect of the present invention is a storage system that has a resource including a first storage and a second storage on a cloud, and executes an operation that includes a plurality of resource operations including copying data stored in a server arranged at another site to the second storage via a first volume provided by the first storage. Further, the storage system includes a processor and a memory. Furthermore, the processor: manages, for each type of the operation, a correspondence relationship between each state of the resource, the each state being associated with execution of each of the resource operations, and a transition destination state indicating the state to which the each state is to make a transition when the execution of each of the resource operations is completed; executes the resource operation included in the operation; manages a current state that is the state of the resource, the state being associated with the execution of the resource operation; obtains an execution result indicating whether the execution of the resource operation has been completed normally; obtains the transition destination state associated with the current state, based on the execution result and the correspondence relationship; and determines the state to which the current state is to make a transition, based on the acquired transition destination state.

According to the present invention, it is possible to easily perform operations including a series of storage operations in a hybrid cloud.

### BRIEF DESCRIPTION OF THE DRAWINGS

FIG. 1 is a diagram illustrating the configuration of a cloud system according to an embodiment;

FIG. 2 is a diagram illustrating the formation of a state management table according to the embodiment;

FIG. 3A is a diagram illustrating the formation of a transition destination list table (migration) according to the embodiment;

FIG. 3B is a diagram illustrating the formation of a transition destination list table (secondary use) according to the embodiment;

FIG. 4 is a diagram illustrating the formation of a storage resource management table according to the embodiment;

FIG. 5 is a flowchart illustrating a state management process according to the embodiment;

FIG. 6 is a flowchart illustrating a normal-time transition destination designating process according to the embodiment;

FIG. 7 is a flowchart illustrating a case continuation process according to the embodiment;

FIG. 8 is a flowchart illustrating an abnormal-time transition destination designating process according to the embodiment;

FIG. 9 is a flowchart illustrating a deletion determining process according to the embodiment;

FIG. 10 is a diagram illustrating the formation of a menu screen according to the embodiment;

FIG. 11 is a diagram illustrating the formation of a case selection screen according to the embodiment;

FIG. 12 is a diagram illustrating the formation of a normal-time transition instruction screen according to the embodiment;

FIG. 13 is a diagram illustrating the formation of a redo instruction screen according to the embodiment;

FIG. 14 is a diagram illustrating the formation of a deletable display screen according to the embodiment;

FIG. 15 is a diagram illustrating the formation of an undeletable display screen according to the embodiment; and

FIG. 16 is a diagram illustrating the hardware configuration of a computer.

### DETAILED DESCRIPTION OF THE PREFERRED EMBODIMENTS

Hereinafter, an embodiment of the present invention will be described in detail with reference to the drawings. Note that the following description and drawings are merely examples for describing the present invention, and some parts have been omitted or simplified appropriately for clarity of description. Furthermore, not all of the combinations of features described in the embodiments are necessarily essential to the solution of the invention. The present invention is not limited to the embodiments, and all application examples that conform to the concept of the present invention are included in the technical scope of the present invention. Those skilled in the art may make various additions and modifications to the present invention within the scope of the present invention. The present invention can be implemented in various other forms. Unless otherwise specified, each component may be a plurality of components or a single component.

In the following description, a “central processing unit (CPU)” is an example of one or more processor devices. At least one processor device is typically not limited to a CPU, but may be another type of processor device such as a graphics processing unit (GPU). At least one processor device may be a single-core device or a multi-core device. At least one processor device may be a processor core.

At least one processor device may be a circuit that is an aggregation of gate arrays written in a hardware description language to perform some or all of the processes. A circuit is a processor device in a broad sense, such as a field-programmable gate array (FPGA), a complex programmable logic device (CPLD), or an application specific integrated circuit (ASIC), for example.

In the following description, a processing function called an “XXX unit” is achieved by executing a program by a CPU, and becomes the executing subject of the processing. The processing functions may be achieved by one or more computer programs being executed by a processor, or may be achieved by one or more hardware circuits (e.g., FPGAs or ASICs), or by a combination thereof.

When a function is achieved by executing a program by using a processor, since the specified process is performed appropriately by using a storage device and/or an interface device, etc., the function can be regarded as a part of the processor. The processing described with a functional unit as the subject may be processing performed by a processor or a device having the processor.

The program may be installed from a program source. The program source may be a program distribution computer or a computer-readable recording medium (for example, a non-transitory recording medium), for example. The description of each function is an example, and a plurality of functions may be combined into one function, or one function may be divided into a plurality of functions.

In addition, in the following description, various types of information may be described in table format, but the data format of the information may be a format other than a table format (for example, comma separated values (CSV) format, etc.). Furthermore, the various types of information may be stored in the storage unit as a table, or may be embedded as logic in the program.

In addition, in the following description, when describing elements of the same type without distinction between the elements, common symbols of reference symbols will be used, and when describing elements of the same type with distinction, the reference symbols will be used.

### Configuration of Cloud System S According to an Embodiment

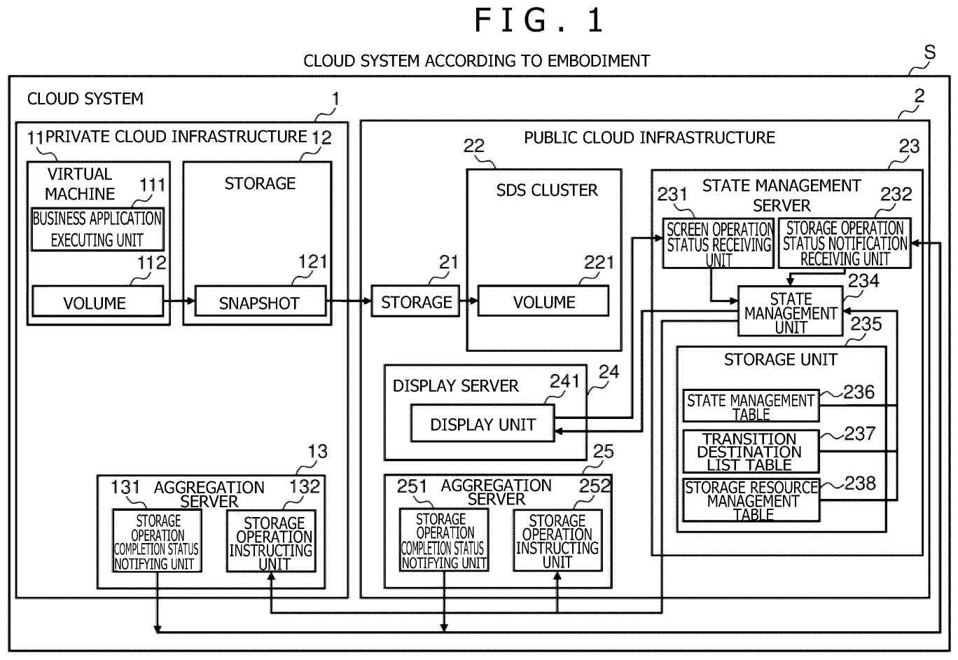

FIG. 1 is a diagram illustrating the configuration of a cloud system S according to an embodiment. The cloud system S is a storage system on a hybrid cloud installed at a cloud site. The cloud system S has a private cloud infrastructure 1 managed for each client and a multi-tenant public cloud infrastructure 2.

The private cloud infrastructure 1 includes a virtual machine 11, a storage 12, and an aggregation server 13. In the private cloud infrastructure 1, the virtual machine 11, the storage 12, and the aggregation server 13 are connected so as to be able to communicate with each other.

The virtual machine 11 is a virtual server to which program data and user data have been migrated from an on-premise physical server (not illustrated) and storage (not illustrated) installed at a site other than the cloud site. Further, the virtual machine 11 is a virtual server for migration that migrates user data migrated from an on-premise resource to the public cloud infrastructure 2. The virtual machine 11 has a business application executing unit 111 and a volume 112 provided to the virtual machine 11 by the storage 12.

The business application executing unit 111 executes a business application. The volume 112 stores program data of the virtual machine 11 migrated from an on-premise resource and user data of a client who uses the virtual machine 11. The volume 112 is an example of a first volume, and is an intermediate volume described below.

The storage 12 is an object storage, for example. The storage 12 acquires and stores a snapshot 121 of user data of the virtual machine 11 stored in the volume 112. The storage 12 is an example of a first storage.

The aggregation server 13 is a virtual machine, and has a storage operation completion status notifying unit 131 and a storage operation instructing unit 132. The storage operation completion status notifying unit 131 transmits the storage operation completion state notification output from the storage 12 after the execution of the storage operation executed in accordance with the executing instruction as the state after the execution to a storage operation status notification receiving unit 232 described below. The storage operation instructing unit 132 transmits to the storage 12 an instruction to execute a storage operation according to the state received from a state management unit 234 to be described later.

The public cloud infrastructure 2 has a storage 21, a software-defined storage (SDS) cluster 22, a state management server 23, a display server 24, and an aggregation server 25. In the public cloud infrastructure 2, the storage 21, SDS cluster 22, state management server 23, display server 24, and aggregation server 25 are connected so as to be able to communicate with each other.

The storage 21 is a block storage, for example, and stores the snapshot 121 that is set to be shared by the private cloud infrastructure 1. The SDS cluster 22 is a storage cluster included in the public cloud infrastructure 2, and imports the snapshot 121 into a volume 221 via the storage 21. The SDS cluster 22 is an example of a second storage.

The state management server 23 is a virtual machine, and includes a screen operation status receiving unit 231, the storage operation status notification receiving unit 232, the state management unit 234, and a storage unit 235.

The screen operation status receiving unit 231 receives the status of user operation on various screens (FIGS. 10 to 15) displayed on a display unit 241 described below, and transmits the status to the state management unit 234. The storage operation status notification receiving unit 232 receives notifications of the completion status of storage operations from storage operation completion status notifying units 131 or 251 of the aggregation servers 13 or 25, and transmits the notifications to the state management unit 234.

The state management unit 234 updates a state management table 236 described below based on the completion status of the storage operation received from the storage operation status notification receiving unit 232. In addition, the state management unit 234 refers to a transition destination list table 237 and a storage resource management table 238, and determines the state to which a transition is to be made next, on the basis of the user's operation status received from the screen operation status receiving unit 231. Then, the state management unit 234 transmits the determined state to storage operation instructing units 132 or 252 of the aggregation servers 13 or 25.

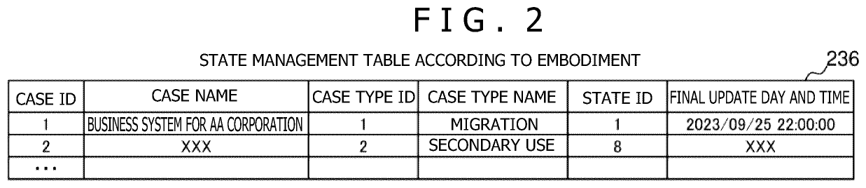

The storage unit 235 is a temporary storage device such as a memory or a permanent storage device such as a storage. The storage unit 235 stores the state management table 236, transition destination list table 237, and storage resource management table 238. The state management table 236, transition destination list table 237, and storage resource management table 238 will be described in detail below with reference to FIGS. 2, 3A, 3B, and 4, respectively.

The display server 24 is a virtual machine and has the display unit 241. The display unit 241 has a display screen (not illustrated) and controls the display of various screens (FIGS. 10 to 15) described below. The display unit 241 displays the information received from the state management unit 234 on the display screen, and transmits the operation status of the user operating the display screen to the screen operation status receiving unit 231.

The aggregation server 25 is a virtual machine, and has a storage operation completion status notifying unit 251 and a storage operation instructing unit 252. The aggregation server 25, storage operation completion status notifying unit 251, and storage operation instructing unit 252 are similar to the aggregation server 13, storage operation completion status notifying unit 131, and storage operation instructing unit 132.

Incidentally, in the present embodiment, the virtual machine 11 for migration is assumed to be a virtual server migrated from a physical server installed on the premise of a client. However, the present invention is not limited to this, and the virtual machine 11 may be a virtual server migrated from any server, such as a virtual server provided in a client's private cloud. The cloud system S has the advantage that, by executing operations via an intermediate volume, it is possible to flexibly combine data migration origins and data migration destinations.

### Configuration of the State Management Table 236 According to the Embodiment

FIG. 2 is a diagram illustrating the formation of the state management table 236 according to the embodiment. The state management table 236 has columns for “Case ID,” “Case name,” “Case type ID,” “Case type name,” “State ID,” and “Last update date and time.”

The “case ID” is identification information of a case that includes a process identified by, for example, a client name, system name, “Case type ID,” and “Case type name.” The “Case name” is the name given to the “Case ID.” The “Case type ID” is the type of operation pattern that includes a series of storage operations executed in the case identified by the “Case ID.” The “Case type name” is the name given to the “Case ID.” The “Status ID” is identification information for the state that indicates the execution status of the processing of the case identified by the “Case ID.” The “Last update date and time” is the timestamp of the corresponding record.

### Configuration of Transition Destination List Table 237 According to the Embodiment

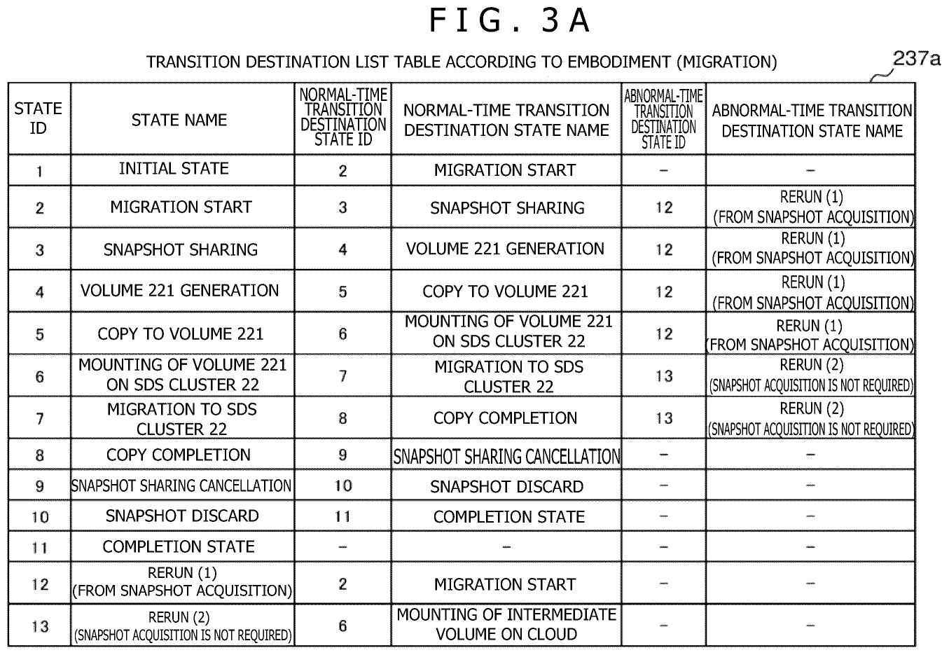

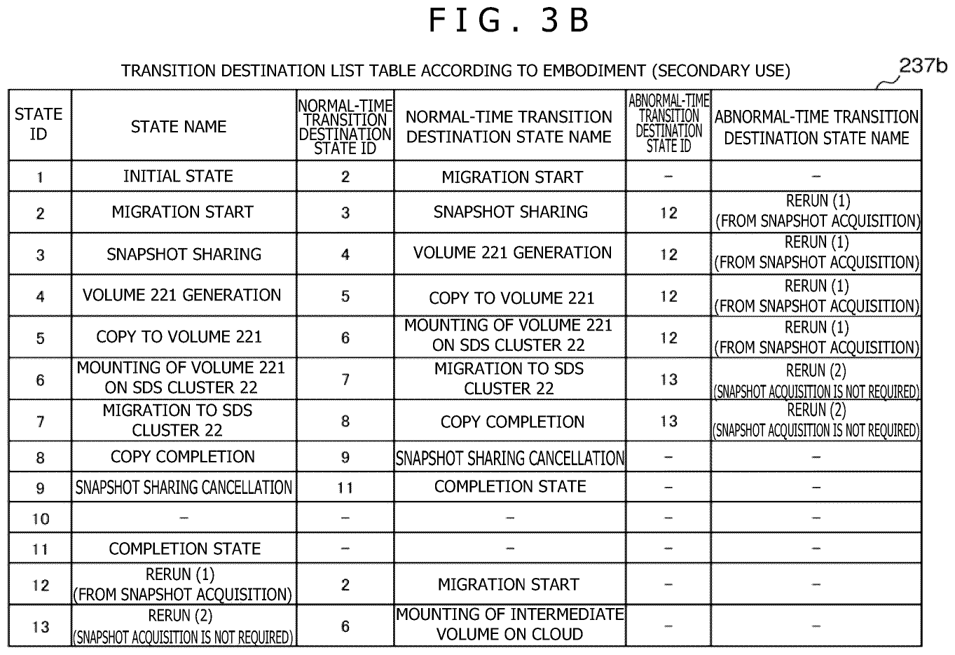

FIG. 3A is a diagram illustrating the formation of a transition destination list table (migration) 237a according to the embodiment. FIG. 3B is a diagram illustrating the formation of a transition destination list table (secondary use) 237b according to the embodiment.

The transition destination list table 237 is defined for each case type. The transition destination list tables 237a and 237b illustrated in FIGS. 3A and 3B illustrate a case where there are two case types “migration” and “secondary use.” The “secondary use” refers to an operation that uses data such as the snapshot 121 related to this copy for a purpose other than the original purpose of copying data, and includes analysis using the data, monthly batch processing, and the like.

A case or case type is an example of an operation including a plurality of resource operations. In addition, in the present embodiment, the resource operations are storage operations on the storage 12, storage 21, and SDS cluster 22.

The “migration” and “secondary use” are premised on the creation of the snapshot 121 as an advance preparation. However, the present invention is not limited to this, and the snapshot 121 may be created by the processes of “migration” and “secondary use,” and the range of the advance preparatory stage can be changed as appropriate.

A separate table is provided for the transition destination list table 237 for each additional case type. The plurality of transition destination list tables 237a, 237b, etc. are collectively referred to as the transition destination list table 237.

The transition destination list table 237 has columns of “State ID,” “State name,” “Normal-time transition destination state ID,” “Normal-time transition destination state name,” “Abnormal-time transition destination state ID,” and “Abnormal-time transition destination state name.” The transition destination list table 237 manages the correspondence relationship of the information stored in these columns.

The “State ID” is identification information for the current state that is to make a transition accompanying the execution of a resource operation in the corresponding case. The “State name” is the name given to the “State ID.”

The “Normal-time transition destination state ID” indicates the “State ID” of the destination to which the state identified by the “State ID” is to make a transition when a storage operation executed in the state of the corresponding record is completed normally. The “Normal-time transition destination state name” is the name given to the “Normal-time transition destination state ID.” The “Normal-time transition destination state ID” and “Normal-time transition destination state name” indicate the state to which each state is to make a transition when execution of each resource operation represented by each state is completed. Further, the “Normal-time transition destination state ID” and “Normal-time transition destination state name” also indicate the state to which each state is to make a transition when each resource operation represented by each state is completed normally.

The “Abnormal-time transition destination state ID” indicates the “State ID” of the transition destination to which a transition is made from the state identified by the “State ID” when a storage operation executed in the state of the corresponding record does not complete normally. The “Abnormal-time transition destination state name” is the name given to the “Abnormal-time transition destination state ID.” The “Abnormal-time transition destination state ID” and “Abnormal-time transition destination state name” indicate the state to which each state is to make a transition when the execution of each resource operation represented by each state is completed. In addition, the “Abnormal-time transition destination state ID” and “Abnormal-time transition destination state name” indicate the state to which each state is to make a transition when the resource operation represented by each state ends without normal completion.

Comparing the transition destination list tables 237a with 237b illustrated in FIGS. 3A and 3B, the transition destination list table 237b differs in that the “Normal-time transition destination state ID” corresponding to the “State ID” of “9” is “11” instead of “10.” Also, the transition destination list table 237b differs in that no record is defined for the “State ID” of “10”. The transition destination list tables 237a and 237b are similar to each other except for these points.

For example, “Copy to volume 221” for a “State ID” of “5” in FIG. 3A represents the resource state resulting from the execution of a resource operation to copy data to the second storage via the first volume.

### Configuration of Storage Resource Management Table 238 According to the Embodiment

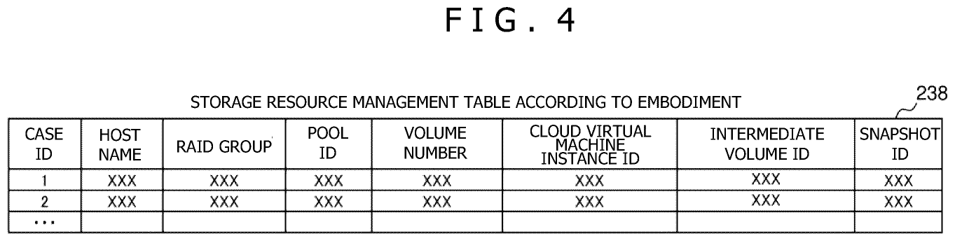

FIG. 4 is a diagram illustrating the formation of the storage resource management table 238 according to the embodiment. The storage resource management table 238 has columns for “Case ID,” “Host name,” “RAID group,” “Pool ID,” “Volume number,” “Cloud virtual machine instance ID,” “Intermediate volume ID,” and “Snapshot ID.”

The “Host name,” “RAID group,” “Pool ID,” and “Volume number” are information related to the physical server or virtual server of a migration object on the client's premises (not illustrated) or in a private cloud.

The “Case ID” is similar to the “Case ID” in the state management table 236. The “Host name” is the host name of the on-premise physical server or virtual server of the migration object. The “RAID group” is configuration information of the redundant arrays of inexpensive disks (RAID) of the storage in which volumes provided to the on-premise physical server or virtual server of the migration object are stored. The “Pool ID” is the identification information of the pool to which the volume provided to the on-premise physical server or virtual server of the migration object belongs. The “Volume number” is the identification information of the volume provided to the on-premise physical server or virtual server of the migration object.

The “cloud virtual machine instance ID” is identification information on the instance of the virtual machine 11. The “Intermediate volume ID” is identification information for the volume 112 that is an intermediate volume of the virtual machine 11. The “Snapshot ID” is identification information of the snapshot 121.

### State Management Process According to the Embodiment

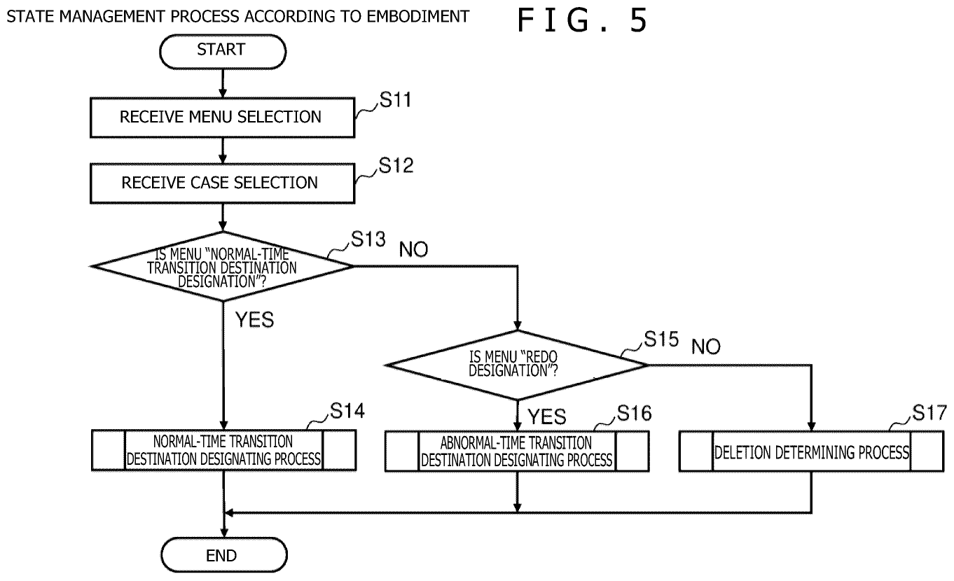

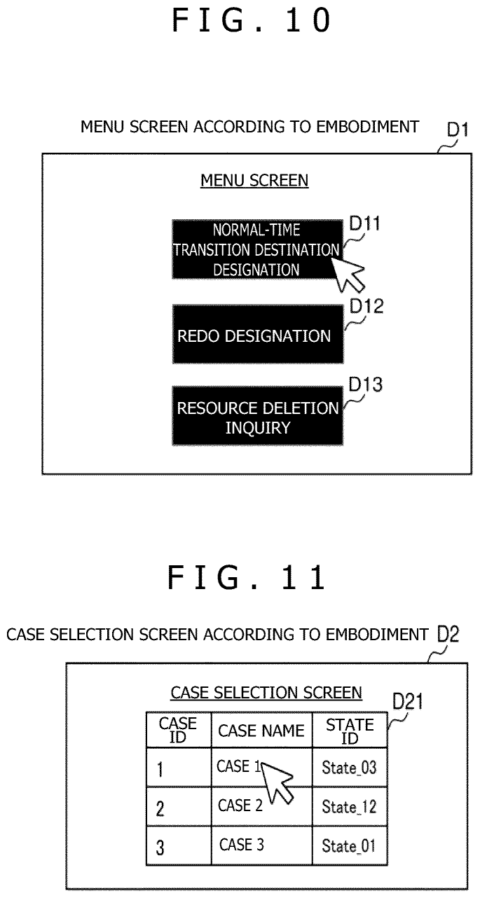

FIG. 5 is a flowchart illustrating state management process according to the embodiment. FIG. 10 is a diagram illustrating the formation of a menu screen D1 according to the embodiment. FIG. 11 is a diagram illustrating the formation of a case selection screen D2 according to the embodiment.

First, in step S11, the screen operation status receiving unit 231 displays the menu screen D1 (FIG. 10) described below on the display screen of the display unit 241, and receives a menu selection by the user via the menu screen D1. In the present embodiment, the menu includes three items “Normal-time transition destination designation,” “Redo designation,” and “Resource deletion inquiry,” for example. When the user selects “Normal-time transition destination designation,” the user operates to select display D11 (FIG. 10), and when the user selects “Redo designation,” the user operates to select display D12 (FIG. 10), and further when the user selects “Resource deletion inquiry,” the user operates to select display D13 (FIG. 10). The selection operation is an operation of the input device of the terminal, such as clicking, tapping, or returning.

Next, in step S12, the screen operation status receiving unit 231 displays the case selection screen D2 (FIG. 11) to be described later on the display screen of the display unit 241, and receives case selection by the user via the case selection screen D2. The user operates to select the record of the case that the user wants to select in a case selection display D21 (FIG. 11).

Next, in step S13, the screen operation status receiving unit 231 determines whether the menu selected in step S11 is a “Normal-time transition destination designation.” The screen operation status receiving unit 231 moves the process to step S14 when the menu is “Normal-time transition destination designation” (YES in step S13), and on the other hand, moves the process to step S15 when the menu is “Redo designation” or “Resource deletion inquiry” (NO in step S13).

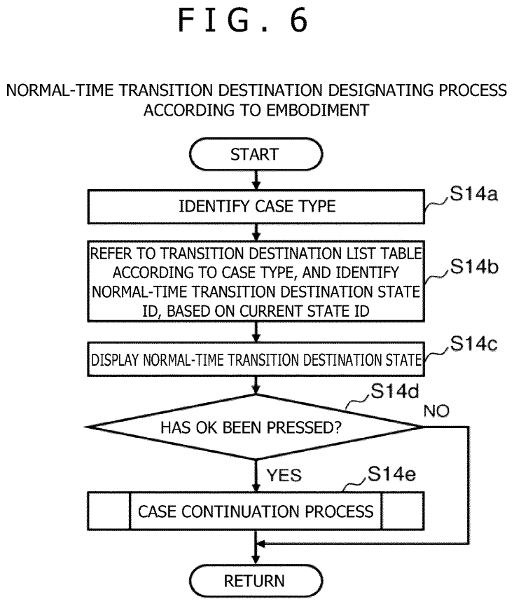

In step S14, the state management unit 234 executes a normal-time transition destination designating process whose details will be described later with reference to FIG. 6.

In step S15, the screen operation status receiving unit 231 determines whether the menu selected in step S11 is “Redo designation.” The screen operation status receiving unit 231 advances the process to step S16 when the menu is “Redo designation” (YES in step S15), and on the other hand, advances the process to step S17 when the menu is “Resource deletion inquiry” (NO in step S15).

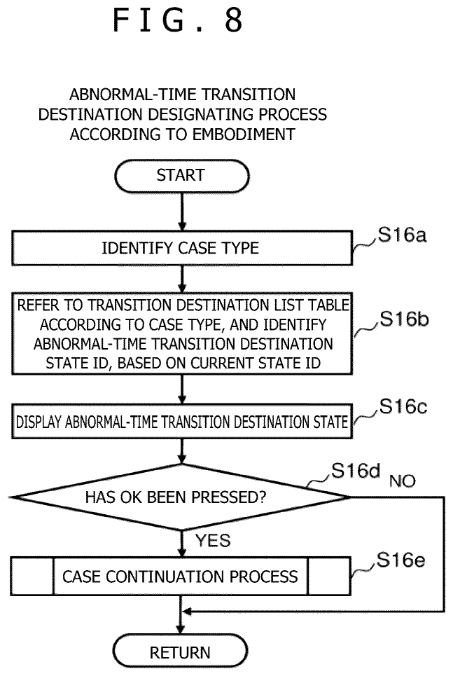

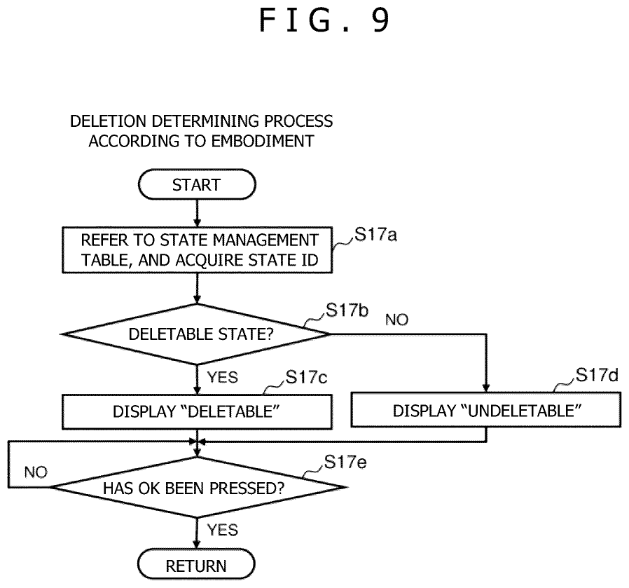

In step S16, the state management unit 234 executes an abnormal-time transition destination designating process whose details will be described later with reference to FIG. 8. In step S17, the state management unit 234 executes a deletion determining process whose details will be described later with reference to FIG. 9.

### Normal-time Transition Destination Designating Process According to the Embodiment

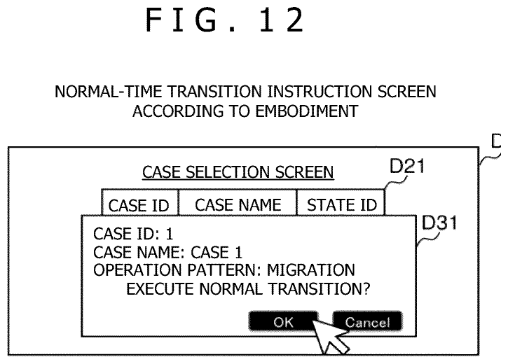

FIG. 6 is a flowchart illustrating normal-time transition destination designating process according to the embodiment. FIG. 12 is a diagram illustrating the formation of a normal-time transition instruction screen D3 according to the embodiment. The normal-time transition destination designating process is executed with the current state ID of the target case stored in the state management table 236 as the starting state. When the normal-time transition destination designating process is executed for the target case for the first time, the current state ID of the target case stored in the state management table 236 is “1.”

First, in step S14a, the state management unit 234 identifies the case type selected in step S12. Next, in step S14b, the state management unit 234 refers to the transition destination list table 237 according to the case type identified in step S14a, and identifies a normal-time transition destination state ID on the basis of the current state ID, and further sets the identified normal-time transition destination state ID as the new current state ID.

Next, in step S14c, the state management unit 234 displays, on the display screen of the display unit 241, a normal-time transition destination state display D31 of the normal-time transition instruction screen D3 (FIG. 12) corresponding to the abnormal-time transition destination state ID identified in step S14b. Next, in step S14d, the state management unit 234 determines whether the OK button of the normal-time transition destination state display D31 has been pressed. When the OK button on the normal-time transition destination state display D31 has been pressed (YES in step S14d), the state management unit 234 proceeds to step S14e. On the other hand, when the cancel button of the normal-time transition destination state display D31 has been pressed (NO in step S14d), the state management unit 234 ends the normal-time transition destination designating process.

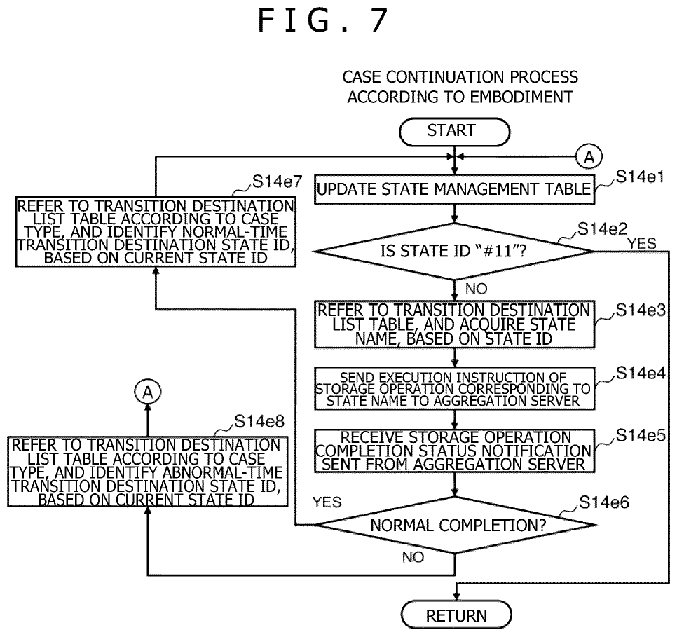

In step S14e, the state management unit 234 executes a case continuation process whose details will be described later with reference to FIG. 7.

### Case Continuation Process According to the Embodiment

FIG. 7 is a flowchart illustrating the case continuation process according to the embodiment. In the case continuation process, the transition destination list table 237 for each case type is referenced, and after the storage operation corresponding to the current state ID is executed, the corresponding normal-time transition destination state ID or abnormal-time transition destination state ID is obtained depending on whether the operation is completed normally or abnormally. Then, a storage operation corresponding to the acquired state ID is executed. After the storage operation is executed, a corresponding normal-time transition destination state ID or abnormal-time transition destination state ID is obtained depending on whether the operation is completed normally or abnormally. In this way, the case continuation process is a process for executing a series of storage operations defined in the transition destination list table 237 while causing the current state to make a transition on the basis of the normal-time transition destination state ID and the abnormal-time transition destination state ID.

First, in step S14e1, the state management unit 234 updates the state ID and the last update date and time of the corresponding case ID in the state management table 236. The state management unit 234 updates the state management table 236 with the current state ID that corresponds to either the normal-time transition destination state ID (identified in step S14b and S14e7) or the abnormal-time transition destination state ID (identified in step S16b and S14e8), and the current date and time.

Next, in step S14e2, the state management unit 234 determines whether the state ID updated in step S14e1 is, for example, “11,” which corresponds to a “Completion state” defined in the transition destination list table 237 according to the case type selected in step S14a or S16a. When the updated state ID is “11” (YES in step S14e2), the state management unit 234 ends the case continuation process, and when the updated state ID is other than “11” (NO in step S14e2), the process proceeds to step S14e3.

Next, in step S14e3, the state management unit 234 refers to the transition destination list table and acquires the state name on the basis of the state ID updated in step S14e1. Next, in step S14e4, the state management unit 234 transmits the instruction of the storage operation corresponding to the state name acquired in step S14e3 to either the storage operation instructing unit 132 or 252 of the aggregation server 13 or 25. The instruction for the storage operation is sent to the storage operation instructing unit 132 of the aggregation server 13 when the storage operation is executed mainly by the private cloud infrastructure 1, such as when the state ID is “1” to “3,” or “12.” In addition, the instruction for the storage operation is sent to the storage operation instructing unit 252 of the aggregation server 25 when the storage operation is executed mainly by the public cloud infrastructure 2, such as when the state ID is “4” to “11,” or “13.” In this manner, the state management unit 234 executes a resource operation corresponding to the state to which the current state is determined to make a transition.

Next, in step S14e5, the state management unit 234 receives notification of the completion status of the storage operation obtained in response to the execution of the storage operation from the storage operation completion status notifying unit 131 or 251 of the aggregation server 13 or 25 to which the instruction of the storage operation has been sent in step S14e4. The notification of the completion status of a storage operation (storage operation completion status notification) includes information on whether the storage operation instructed to be executed has been completed normally. The storage operation completion status notification is an example of the execution result of a storage operation.

Next, in step S14e6, the state management unit 234 determines whether the storage operation completion status notification received in step S14e5 indicates normal completion of the storage operation. When the storage operation completion status notification indicates normal completion of the storage operation (YES in step S14e6), the state management unit 234 proceeds to step S14e7, and when the storage operation completion status notification indicates other than normal completion (such as an abnormality) (NO in step S14e6), the state management unit 234 proceeds to step S14e8.

In step S14e7, the state management unit 234 executes a process similar to the process in step S14b (FIG. 6). On the other hand, in step S14e8, the state management unit 234 refers to the transition destination list table 237 according to the case type, and identifies an abnormal-time transition destination state ID on the basis of the current state ID, thereby setting the identified abnormal-time transition destination state ID as a new current state ID. When step S14e7 or S14e8 ends, the state management unit 234 moves the process to step S14e1.

Incidentally, when step S14e6 is NO, the state management unit 234 may display on the display screen a message indicating that the storage operation has not been completed normally, as well as the resultant state ID of the storage operations that have been completed normally by then, and the corresponding state. Furthermore, when step S14e6 is NO, the state management unit 234 may end the case continuation process.

Furthermore, when the number of times that NO has been determined in step S14e6 exceeds a threshold, the state management unit 234 may end the case continuation process without proceeding to step S14e8. For example, when the number of times that NO has been determined in step S14e6 for the same state ID exceeds a threshold, the state management unit 234 may end the case continuation process without proceeding to step S14e8.

### Abnormal-time Transition Destination Designating Process According to the Embodiment

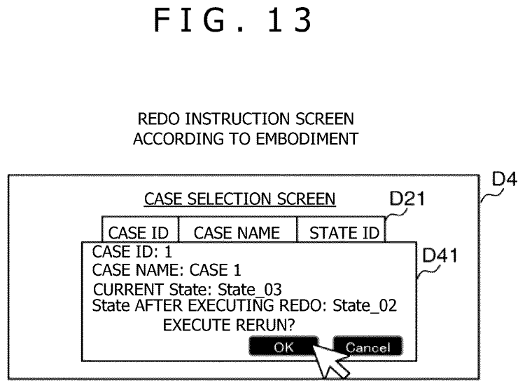

FIG. 8 is a flowchart illustrating an abnormal-time transition destination designating process according to the embodiment. FIG. 13 is a diagram illustrating the formation of a redo instruction screen D4 according to the embodiment. The abnormal-time transition destination designating process is executed to redo a storage operation when a storage operation included in an operation for a certain case does not end normally and the execution of the operation is stopped on the way, or when an erroneous operation is made by the user.

First, in step S16a, the state management unit 234 identifies the case type selected in step S12. Next, in step S16b, the state management unit 234 refers to the transition destination list table 237 according to the case type identified in step S16a, and identifies an abnormal-time transition destination state ID on the basis of the current state ID.

Next, in step S16c, the state management unit 234 displays, on the display screen of the display unit 241, the redo instruction screen D4 (FIG. 13) corresponding to the abnormal-time transition destination state ID identified in step S16b. The redo instruction screen D4 may display the state to which the process must be returned in order to redo the process and whether or not the snapshot 121 needs to be reacquired, based on the “Abnormal-time transition destination state name” in the transition destination list table 237.

Next, in step S16d, the state management unit 234 determines whether the OK button on a redo instruction display D41 on the redo instruction screen D4 has been pressed. When the OK button on the redo instruction display D41 has been pressed (YES in step S16d), the state management unit 234 moves the process to step S16e. On the other hand, when the cancel button on the redo instruction display D41 has been pressed (NO in step S16d), the state management unit 234 ends the abnormal-time transition destination designating process.

In step S16e, the state management unit 234 executes the case continuation process already described in detail with reference to FIG. 7.

### Deletion Determining Process According to the Embodiment

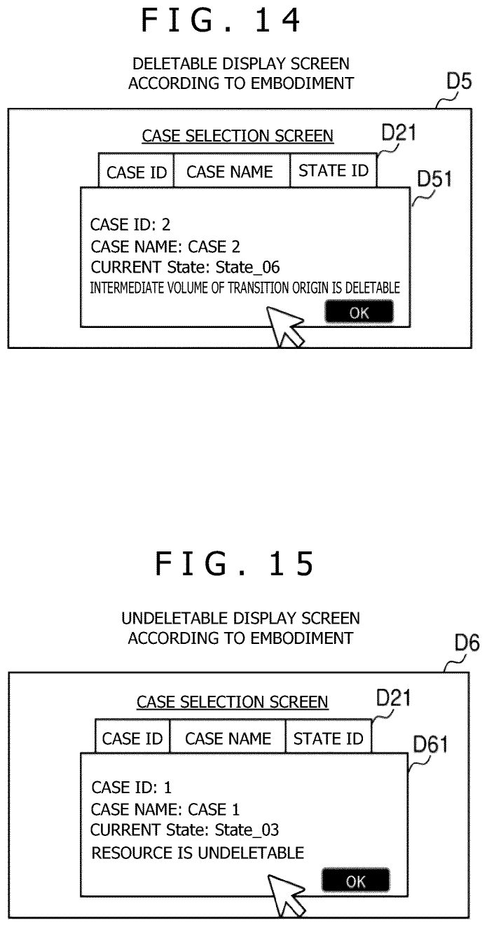

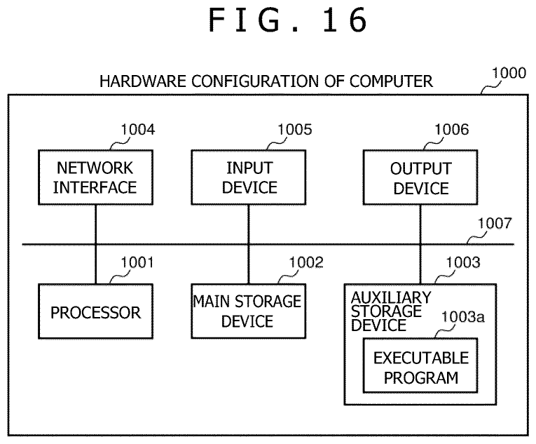

FIG. 9 is a flowchart illustrating the deletion determining process according to the embodiment. FIG. 14 is a diagram illustrating the formation of a deletable display screen D5 according to the embodiment. FIG. 15 is a diagram illustrating the formation of an undeletable display screen D6 according to the embodiment.

First, in step S17a, the state management unit 234 refers to the state management table 236 and acquires the current state ID.

Next, in step S17b, the state management unit 234 determines whether the current state acquired in step S17a is a state in which both the volume 112 and the snapshot 121 can be deleted, or a state in which only the snapshot 121 can be deleted. The volume 112 and the snapshot 121 can be deleted when the state ID is “1” to “5” in the transition destination list table 237 according to the case type. Only the snapshot 121 can be deleted without deleting the volume 112 when the state ID is “6” or “7” in the transition destination list table 237 according to the case type.

When the current state is a state in which both the volume 112 and the snapshot 121 can be deleted or a state in which only the snapshot 121 can be deleted (YES in step S17b), the state management unit 234 proceeds to step S17c. On the other hand, when deletion is impossible for any of the items (NO in step S17b), the state management unit 234 moves the process to step S17d.

In step S17c, the state management unit 234 displays on the display screen of the display unit 241 the deletable display screen D5 (FIG. 14) indicating that the intermediate volume and the snapshot 121, or only the snapshot 121 can be deleted according to the current state ID. At this time, the state management unit 234 also displays the current state on the display screen of the display unit 241.

On the other hand, in step S17d, the state management unit 234 displays on the display screen of the display unit 241 the undeleatable display screen D6 (FIG. 15) indicating that none of the resources, namely neither the volume 112 nor the snapshot 121 can be deleted under the current state ID. At this time, the state management unit 234 also displays the current state on the display screen of the display unit 241. At this time, the state management unit 234 may also display the period (state) for which deletion is possible. When step S17c or S17d ends, the state management unit 234 advances the process to step S17e.

Note that in the case of an operation using only the volume 112 and not using the snapshot 121, a determination is made only as to whether or not the volume 112 can be deleted, and the result of this determination is displayed.

In step S17e, the state management unit 234 determines whether the OK button of a deletable display D51 on the deletable display screen D5 or an undeletable display D61 on the undeletable display screen D6 has been pressed. The state management unit 234 waits until the OK button of the deletable display D51 or the undeletable display D61 has been pressed (NO in step S17e), and ends the deletion determining process when the OK button has been pressed (YES in step S17e). When the OK button of the deletable display D51 has been pressed, the state management unit 234 may send an instruction to delete the intermediate volume and the snapshot 121, or only the snapshot 121 to the storage operation instructing unit 252. When receiving this deletion instruction, the storage operation instructing unit 252 instructs the storage 21 to delete the corresponding intermediate volume and the snapshot 121, or only the snapshot 121.

### Effects of the Embodiment

In the present embodiment, the transition destination to which the current state is to make a transition is determined based on the transition destination list table 237. Therefore, by defining the state transition destination depending on the type of operation including a plurality of resource operations, it is possible to manage the states of a plurality of operations of different types. Furthermore, since it is easy to determine from what state each operation should be started or resumed, operations can be easily executed.

Furthermore, in the present embodiment, based on the transition destination list table 237, a normal-time transition destination state to which the transition is made when the resource operation corresponding to the current state is completed normally or an abnormal-time transition destination state to which the transition is made when the resource operation is completed abnormally is chosen as the transition destination, and the corresponding resource operation is executed. Therefore, the next state to which a transition should be made can be easily determined depending on whether the resource operation has been completed normally or abnormally, and the operation can be performed automatically.

In addition, in the present embodiment, when the abnormal-time transition destination state is obtained based on the execution results of each resource operation of the operation and the transition destination list table 237, the current state and the abnormal-time transition destination state are displayed on the redo instruction screen D4. Therefore, it is easy to determine to what state an operation must be returned in order to be redone.

Furthermore, in the present embodiment, it is determined based on the current state whether the first volume (volume 112) and the snapshot 121, or only the snapshot 121 can be deleted. Then the result of the determination as to whether the first volume is deletable or not is displayed on the deletable display screen D5 or the undeletable display screen D6, together with the current state. Therefore, in the current state, it is easy to determine whether it is permissible to delete the first volume of the migration origin and the snapshot 121, or only the snapshot 121.

In the present embodiment, the operation is a migration. Accordingly, the present embodiment can be applied to cases where data is migrated from an on-premise storage device to a storage device in a public cloud via an intermediate volume in a client-managed private cloud. Further, in the present embodiment, the operation is a secondary use. Therefore, the present embodiment can be applied to the secondary use of data stored in an intermediate volume when data is migrated from an on-premise storage device to a storage device in a public cloud via an intermediate volume in a client-managed private cloud.

### Hardware Configuration of Computer 1000

FIG. 16 is a diagram illustrating the hardware configuration of a computer 1000. The computer 1000 executes a predetermined program to achieve each server and storage (FIG. 1), various input/output terminals, and the like of the private cloud infrastructure 1 and the public cloud infrastructure 2.

The computer 1000 has a processor 1001 including a CPU, a main storage device 1002, an auxiliary storage device 1003, a network interface 1004, an input device 1005, and an output device 1006, which are interconnected via an internal communication line 1007 such as a bus.

The processor 1001 controls the operation of the entire computer 1000. The main storage device 1002 includes a volatile semiconductor memory, for example, and is used as a work memory for the processor 1001. The auxiliary storage device 1003 includes a large-capacity non-volatile storage device such as a hard disk device, solid state drive (SSD), or flash memory, and is used to store various programs and data for long periods of time.

An executable program 1003a stored in the auxiliary storage device 1003 is loaded into the main storage device 1002 when the computer 1000 is started up or when necessary, and is executed by the processor 1001.

Incidentally, the executable program 1003a may be recorded on a non-transitory recording medium, and read from the non-transitory recording medium by a media reading device, thereby loaded into the main storage device 1002. Alternatively, the executable program 1003a may be obtained from an external computer via a network and loaded into the main storage device 1002.

The auxiliary storage device 1003 stores the executable program 1003a that functions as servers and storages of the private cloud infrastructure 1 and the public cloud infrastructure 2.

The network interface 1004 is an interface device for connecting the computer 1000 to each network in a system or for communicating with other computers. The network interface 1004 includes a network interface card (NIC) for a wired local area network (wired LAN), a wireless LAN, or the like.

The input device 1005 includes a keyboard, a pointing device such as a mouse, and the like, and is used by the user to input various instructions and information to the computer 1000. The output device 1006 includes a display device such as a liquid crystal display or an organic electro luminescence (organic EL) display, or an audio output device such as a speaker, for example, and is used to present necessary information to the user as needed.

Although the embodiments according to the present disclosure have been described above in detail, the present disclosure is not limited to above-described the embodiments, and various modifications are possible without departing from the spirit and scope of the present disclosure. For example, the above-described embodiment has been described in detail to clearly explain the present invention, and the present invention is not necessarily limited to having all of the described configurations. Furthermore, some of the configurations of the above-described embodiments can be subjected to addition of other configurations, deletion, or replacement with other configurations.

Further, the above-described configurations, functional units, processing units, etc. may be partly or entirely achieved in hardware, for example, by designing these as integrated circuits. Furthermore, each of the above-described configurations, functions, etc. may be achieved in software by a processor interpreting and executing a program that fulfills each function. Information such as programs, tables, and files that implement each function can be stored in a storage device such as a memory, an HDD, or an SSD, or a recording medium such as an IC card, an SD card, or a DVD.

In addition, in each of the above figures, the control lines and information lines illustrated are those that are considered necessary for description, and do not necessarily illustrate all of the mounted control lines and information lines. For example, in reality, it can be considered that almost all components are connected to each other.

Furthermore, the above-mentioned arrangement form of each processing function and data is merely an example. The arrangement form of each processing function and data can be changed to an optimal arrangement form in terms of hardware and software performance, processing efficiency, communication efficiency, etc.

What is claimed is:

1. A storage system that has a resource including a first storage and a second storage on a cloud, and executes an operation that includes a plurality of resource operations including copying data stored in a server arranged at another site to the second storage via a first volume provided by the first storage,
the storage system comprising: a processor and a memory,
the processor
managing, for each type of the operation, a correspondence relationship between each state of the resource, the each state being associated with execution of each of the resource operations, and a transition destination state indicating the state to which the each state is to make a transition when the execution of each of the resource operations is completed,
executing the resource operation included in the operation,
managing a current state that is the state of the resource, the state being associated with the execution of the resource operation,
obtaining an execution result indicating whether the execution of the resource operation has been completed normally,
obtaining the transition destination state associated with the current state, based on the execution result and the correspondence relationship, and
determining the state to which the current state is to make a transition, based on the acquired transition destination state.

2. The storage system according to claim 1, wherein the processor
manages, for each type of the operation, the correspondence relationship between the each state, a normal-time transition destination state indicating the state to which the each state is to make a transition when the each of the resource operations is terminated with normal completion, and an abnormal-time transition destination state indicating the state to which the each state is to make a transition when the each of the resource operations is terminated without normal completion,
obtains the normal-time transition destination state or the abnormal-time transition destination state that is associated with the current state, based on the execution result and the corresponding relationship,
determines the state to which the current state is to make a transition, based on the acquired normal-time transition destination state or the acquired abnormal-time transition destination state, and
executes the resource operation corresponding to the determined state to which the current state is to make a transition.

3. The storage system according to claim 2, wherein the processor,
when obtaining the abnormal-time transition destination state on a basis of the execution result and the correspondence relationship, displays the current state and the abnormal-time transition destination state on a display screen.

4. The storage system according to claim 1, wherein the processor
determines whether the first volume can be deleted, based on the current state, and
displays a result of the determination as to whether the first volume can be deleted on a display screen, together with the current state.

5. The storage system according to claim 4, wherein the processor
creates a snapshot of the data when copying the data from the first volume to the second storage,
copies the snapshot from the first storage to the second storage,
determines whether the first volume and the snapshot can be deleted or only the snapshot can be deleted, based on the current state, and
displays a result of the determination as to whether the first volume and the snapshot can be deleted or only the snapshot can be deleted on a display screen, together with the current state.

6. The storage system according to claim 1, wherein the operation
is a migration of the data from the first storage to the second storage.

7. The storage system according to claim 1, wherein the operation
is a secondary use of the data stored in the first storage for a purpose other than the copying.

8. A method of managing a state of a resource operation executed by a storage system that has a resource including a first storage and a second storage on a cloud, and executes an operation that includes a plurality of resource operations including copying data stored in a server arranged at another site to the second storage via a first volume provided by the first storage,
the storage system including a processor and a memory,
the method comprising:
by the processor,
managing, for each type of the operation, a correspondence relationship between each state of the resource, the each state being associated with execution of each of the resource operations, and a transition destination state indicating the state to which the each state is to make a transition when the execution of each of the resource operations is completed;
executing the resource operation included in the operation;
managing a current state that is the state of the resource, the state being associated with the execution of the resource operation;
obtaining an execution result indicating whether the execution of the resource operation has been completed normally,
obtaining the transition destination state that is associated with the current state, based on the execution result and the correspondence relationship; and
determining the state to which the current state is to make a transition, based on the acquired transition destination state.

9. The method of managing a state of a resource operation according to claim 8,
the method comprising:
by the processor,
managing, for each type of the operation, the correspondence relationship between the each state, a normal-time transition destination state indicating the state to which the each state is to make a transition when the each of the resource operations is terminated with normal completion, and an abnormal-time transition destination state indicating the state to which the each state is to make a transition when the each of the resource operations is terminated without normal completion;
obtaining the normal-time transition destination state or the abnormal-time transition destination state that is associated with the current state, based on the execution result and the corresponding relationship;
determining the state to which the current state is to make a transition, based on the acquired normal-time transition destination state or the acquired abnormal-time transition destination state; and
executing the resource operation corresponding to the determined state to which the current state is to make a transition.

10. The method of managing a state of a resource operation according to claim 8,
the method comprising:
by the processor,
determining whether the first volume can be deleted, based on the current state, and
displaying a result of the determination as to whether the first volume can be deleted on a display screen, together with the current state.
